(19) United States
(12) Patent Application Publication
(10) Pub. No.: US 2010/0323757 A1
(43) Pub. Date: Dec. 23, 2010

(54) Method and Device for Managing Data Using a Memory Module in a Cellular Phone

(75) Inventors: Matthew M. Seflic, Chicago, IL (US); Julio C. Castaneda, Coral Springs, FL (US); Adam Cybart, McHenry, IL (US); Matthew S. MacQueen, Chicago, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/630,039

(22) Filed: Dec. 3, 2009

Related U.S. Application Data
(60) Provisional application No. 61/218,519, filed on Jun. 19, 2009.

(51) Int. Cl. H04M 1/00

(52) U.S. Cl. 455/557

(57) ABSTRACT

A method and device for managing data in a cellular phone is disclosed. The method includes providing a cellular phone with a memory module configured to receive more than one removable storage medium simultaneously. At least two removable storage media are coupled to the memory module and data is managed between the two removable storage media using the memory module for use in connection with the cellular phone. The method and device can allow easy and fast management of data with a cellular phone using a memory module capable of simultaneously receiving and processing multiple removable storage media. A visual aid can be used, to allow a user to monitor the progress of the data management.

### FIELD OF THE DISCLOSURE

The present disclosure relates generally to managing data at a cellular phone and more particularly to managing data using a memory module in a cellular phone.

### BACKGROUND

The wide variety and nature of cellular phones and their increasingly common presence in the workplace, at home, and as personal convenience devices carried on the person leads to frequent circumstances in which data that was stored, received, and/or processed on one device may be desired to be transferred to another device at the same or a different location. However, such cellular phones do not accommodate any form of removable mass storage such as floppy disks or optical disks. This need has resulted in the development of removable storage devices embodied in media such as solid state memory cards to allow stored data to be transferred from device to device.

However, due to technical limitations, most of the current removable storage devices are only provided with the storage medium having limited storage capacity. This has limited the ability for a person to readily carry along an adequate storage capacity. When there is a need for large data storage and transfer exceeding the storage capacity, the removable storage device has to be cleared of some data in order to make some storage space available. In practice, some of the data on the removable storage media is either transferred to embedded storage of the cellular phone or to another electronic device having storage media in order to create free storage space. Such methods of data management are tedious and time consuming.

Further, current techniques of data sharing from a first cellular phone to a second cellular phone include removing the removable storage device from the first cellular phone and inserting into the second device or transferring data to the second device by means of establishing communication through wired or wireless medium e.g., via Bluetooth, data cable, LAN, WiFi, etc. Existing methods of sharing data via wireless medium are often cumbersome and limiting in the amount of data that can be shared. Thus, the current techniques do not facilitate easy and quick sharing of data between multiple storage devices at a cellular phone.

Accordingly, there is a need for a method for managing data using a memory module in a cellular phone.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication system according to one embodiment;

FIG. 2 is an exemplary block diagram of a cellular phone according to one embodiment;

FIG. 3 is an exemplary flowchart of a method of managing data using a memory module in a cellular phone according to one embodiment;

FIG. 4 is an exemplary flowchart of a method of managing data using a memory module in a cellular phone according to another embodiment;

FIG. 5 is an illustration of a location of removable storage media within the memory module on the cellular phone;

FIG. 6 is an illustration of a removable storage medium's connection to the memory module; and

FIG. 7 shows an illustration of the memory module being expressed as a visual representation on a user interface of the cellular phone.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Various embodiments of the invention disclose a method of managing data in a cellular phone, the method includes providing a cellular phone with a memory module configured to receive more than one removable storage medium simultaneously. At least two removable storage media are coupled to the memory module and data is managed between the two removable storage media using the memory module for use in connection with the cellular phone.

In an embodiment, the cellular phone is provided with a memory module. The cellular phone detects whether a removable storage medium is connected to the memory module. A visual representation of the removable storage medium is rendered in real-time and data is managed with the memory module using the visual representation as a visual aid.

Before describing in detail the method of managing data using a memory module in a cellular phone, it should be observed that the present invention resides primarily in combinations of method steps and device components related to managing data in a cellular phone. Accordingly, the method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

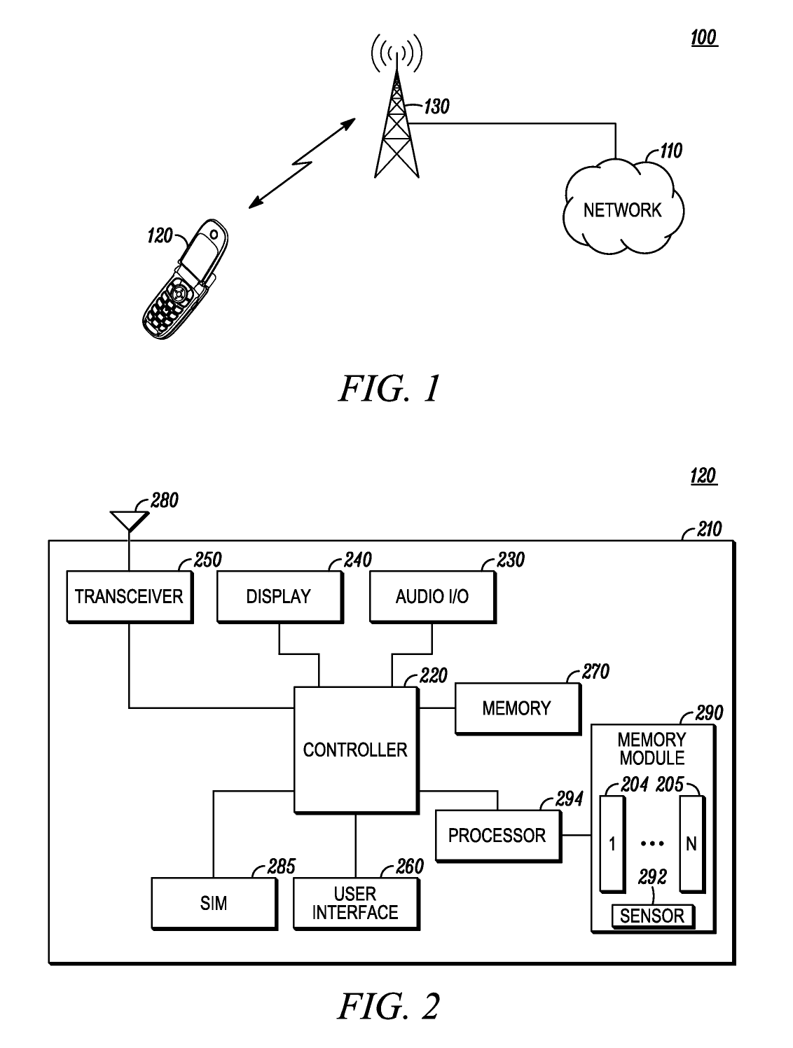

FIG. 1 is an exemplary block diagram of a system 100 according to one embodiment. The system 100 can include a network 110, a terminal 120, and a base station 130. The terminal 120 may be a wireless communication device, such as a cellular phone, a personal digital assistant, or a pager. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network and other like communications systems. In operation, the cellular device 120 can communicate with the network 110 and with other devices on the network 110 by sending and receiving wireless signals via the base station 130.

FIG. 2 is an exemplary block diagram of a cellular phone 120 configured with a memory module 290. The cellular phone 120 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, an antenna 280 coupled to the housing 210 and the transceiver 250, and a subscriber identification module 285 coupled to the controller 220.

In one embodiment, the memory module 290 includes at least two receptacles configured to receive a first removable storage medium 204 and a second removable storage medium 205 referred herein as Dub Drives. Dub Drives are dual externally accessible removable storage media. A removable storage medium is a storage medium that can be removed from and inserted into the cellular phone and other compatible electronic devices irrespective of the operating system running on the respective devices. Examples of a removable storage medium are Secure Digital (SD) memory cards and MultiMedia Cards (MMC), a microdrive memory card, a Memory Stick card, CompactFlash (CF) card, or a MultiMediaCard (MMC). The removable storage medium (204 or 205) is connected to the memory module 290 via a connector such as a standard serial or parallel, wired or wireless connector. Examples of connector standards include Universal Serial Bus (USB), FireWire, Small Computer System Interface (SCSI). The memory module 290 includes a sensor 292 and processor module 294, which are coupled to the controller 220. Alternatively, the processor 294 can reside within the controller 220.

The display 240 can be a liquid crystal display (LCD), a light emitting diode (LED) display, a plasma display, or any other means for displaying image and information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 includes embedded memory such as a random access memory, a read only memory, etc.

In more detail, the cellular phone 120 shown in FIG. 2, includes: a housing 210; a controller 220 coupled to the housing 210, the controller 220 configured to control the operations of the cellular phone; a transceiver 250 coupled to the controller 220; and memory module 290 coupled to the controller 220 and configured to receive more than one removable storage medium e.g., Dub Drives. In an embodiment the memory module 290 is a memory card reader that interfaces with a connector, the memory module comprising a housing configured to receive different types of removable memory cards, interface circuitry that interconnects the different types of removable memory cards and the connector and is adapted to allow communication therebetween.

In an embodiment, the memory module 290 enables quick and easy management of data on the cellular phone 120. In instances where data has to be shared between a first cellular phone and a second cellular phone or between a cellular phone and a computer, the memory module 290 provides a simple and fast means of sharing data. The memory module 290 as shown in FIG. 5, includes at least two receptacles 206 (or recesses) each capable of receiving a removable storage medium. Data can thus be easily managed between two removable storage media using the memory module 290. In an example, when data needs to be shared from a first cellular phone to a second cellular phone or a computer, the receptacles 206 of the memory module 290 of the first cellular phone 120 are each populated by a first 204 and a second removable storage medium 205, the second removable storage medium 205 pertaining to the second cellular phone or computer. Using the user interface 260 and the controller 220 of the first cellular phone 120, data from the first storage medium can be dubbed, moved, copied, etc. to the second removable storage medium on the cellular phone 120 and vice-versa. Similarly, data from the embedded memory of the first storage medium can be shared with the second storage medium on the first cellular phone and vice-versa.

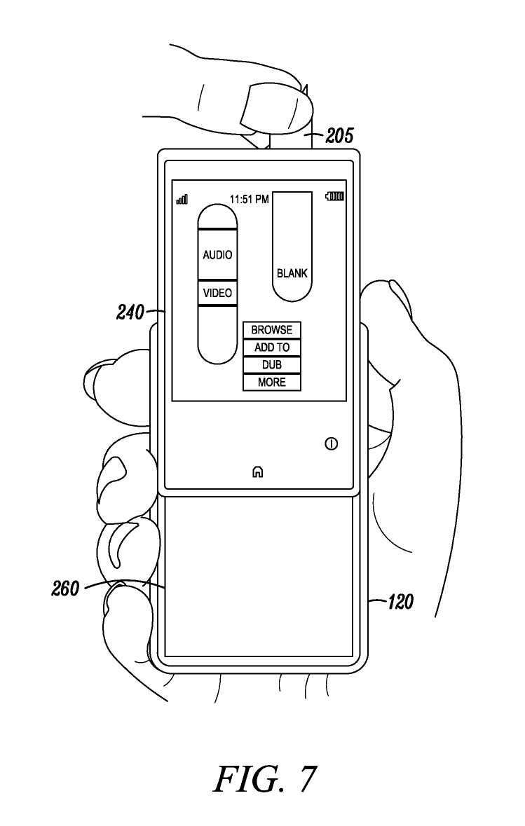

In an embodiment as shown in FIG. 7, a visual representation of Dub Drives (204 and 205) is provided on the display 240. The display 240 acts as a user interface that enables user interaction via tactile input. The display 240 thus allows a user to manage data using the visual representation. For example, the visual representation can show an image representing the first storage medium and an image representing the second storage medium. The image representing the Dub Drives (204 and 205) may show details regarding the stored content such as audio, video, data, etc. In order to explore the content, say video content, the user may touch the image part that represents video content and a list of the video content may be provided on the display 240. Also, if the content has to be managed, i.e., if data has to be moved, copied, dubbed, shared, transferred, etc. between the first 204 and the second removable storage media 205, the user can do so using the visual representation. For example, the user can select the required item from the image of the first storage medium and drag and drop the item directly onto the image of the second storage medium. A transfer of item from the first storage medium to the second storage medium can also be visually represented. Alternatively, the user can manage content using an options menu provided on the display 240. For example, the options menu may include data management options such as browse, add, dub, move, copy, edit, properties, etc.

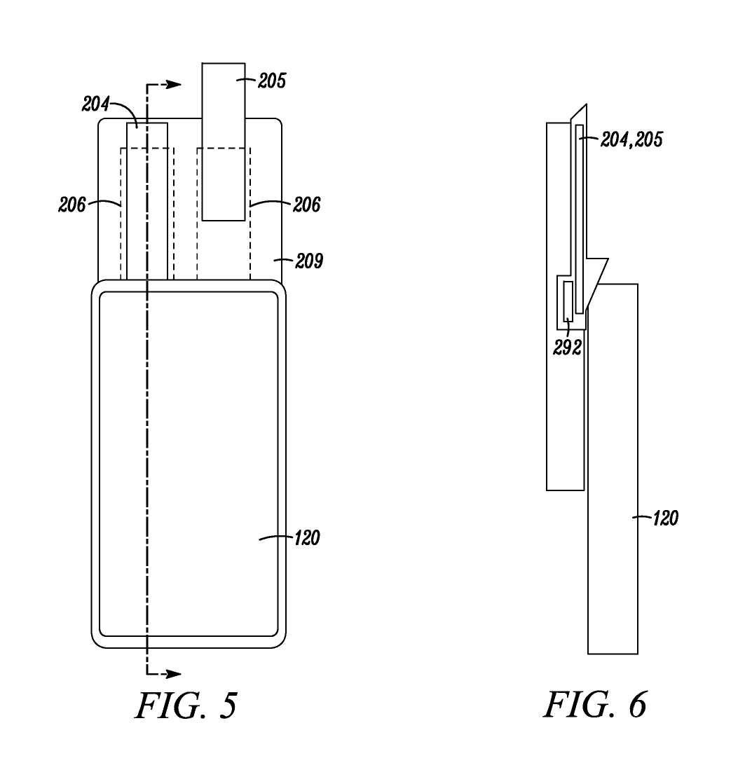

In another embodiment as shown in FIG. 6, the memory module 290 includes a sensor 292 for sensing a position of a removable storage medium 204 or 205 inside the memory module 290 in real-time. Examples of the sensor 292 include optical sensor, capacitive sensor, inductive sensor, magnetic sensor etc. In an embodiment, the sensor 292 acts as an electrical contact between the removable storage medium 204, 205 and the processor 294. The sensor 292 is configured to detect a physical position or orientation of a removable storage medium (204 or 205) inside the receptacle of the memory module 290. In other words, the sensor 292 senses a movement of the removable storage medium 204 or 205 within the memory module 290 in real-time. Here real-time refers to a given instance of time during which a process occurs and movement refers to a change in position. For example, the sensor 292 senses a movement of the removable storage medium 204 or 205 inside the memory module 290 as and when the receptacle 206 receives the removable storage medium 204 or 205 i.e. during insertion of the removable storage medium 204 or 205 inside the memory module 290. Similarly, the sensor 292 senses a movement of the removable storage medium 204 or 205 as and when the removable storage medium 204 or 205 is removed from the memory module 290. Alternatively, for the purpose of detecting the insertion or removal of the removable storage medium, one or more mechanical detect switches that physically touch the removable storage medium can be employed. The sensor 292 (or switch) then provides the detected position signals to the processor 294 in real-time for further processing.

In an embodiment, the processor 294 receives the position signals from the sensor 292 and translates the position signals into image data. Here, the image data refers to a visual representation of the movement of the removable storage medium (204 or 205) inside the memory module 290 in real-time, as shown in FIG. 7. The processor 294 then renders the image data on the display 240 such that when a removable storage medium 204 or 205 is, for example, inserted into the memory module 290, a visualization of the removable storage medium 204 or 205 being inserted is provided on the display 240. A similar visual representation is provided when the removable storage medium (204 or 205) is removed from the memory module 290. In an embodiment as shown in FIG. 7, the visual representation of the Dub Drives 204, 205 includes additional information relating to the Dub Drives 204, 205 such as available storage space, used storage space, content etc. The visual representation may also include an options menu for managing data.

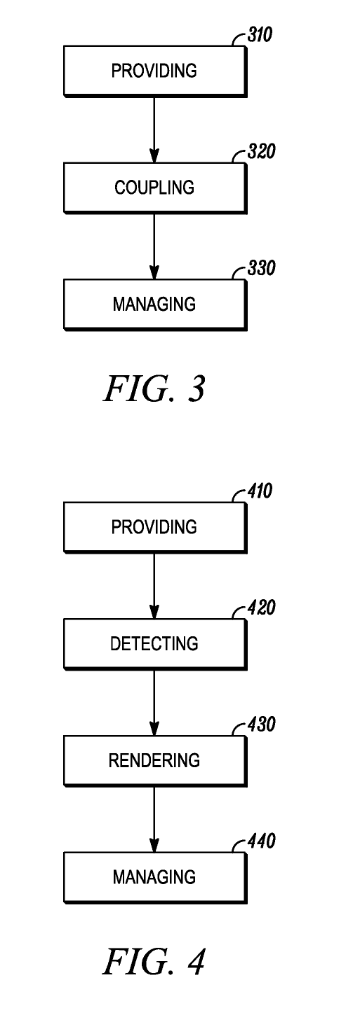

Referring to FIG. 3, a method of managing data using a memory module in a cellular phone is shown. In its simplest form, it includes: providing 310 a cellular phone with a memory module; coupling 320 at least a first and a second removable storage medium to the memory module; and managing 330 data with the memory module, for use in connection with a cellular phone. Advantageously, data from the first storage medium can be easily and quickly shared with the second storage medium or vice-versa, on a first cellular phone.

In more detail and in a preferred embodiment, the providing step 310 can include locating the memory module within the housing of the cellular phone. Further, the memory module can be provided with at least two receptacles for receiving the first and the second removable storage media.

In one embodiment, the coupling step 320, can include electrically connecting the first and second removable storage media to the memory module via a serial or a parallel connection. In an embodiment, coupling the first and the second removable storage media to the memory module includes populating at least the first and the second removable storage medium to the memory module inside or partially inside the cellular phone.

The memory module may employ a contact or a sensor for detecting whether at least one of the removable storage media is coupled to the memory module. Using the sensor's output signals, a visual representation of the first and second removable memory media is provided.

The managing step 330, can include managing data by sharing, dubbing, copying, etc. In one embodiment, data is managed between the first removable storage medium and the second removable storage medium using a visual representation, such as with a display. Stated differently, the memory module can include managing data between the first removable storage medium and the second removable storage medium using the visual representation, where a display on which the visual representation is rendered functions as a user interface. Advantageously, the user can see that the desired operation is being carried out, if desired.

Referring to FIG. 4, an exemplary alternative flowchart illustrating a method of managing data using a memory module in a cellular phone is shown. In its simplest form, it includes: providing 410 a cellular phone with a memory module; detecting 420 whether a removable storage medium is connected to the memory module; rendering 430 a visual representation of the removable storage medium's connection to the memory module, in real-time; and managing 440 data with the memory module.

In more detail, the providing step 410 can include providing a memory module having multiple receptacles or slots. Each receptacle of the memory module can be configured to receive a removable storage media such that the memory module can simultaneously receive and electrically connect with a plurality of removable storage media.

The memory module can be further configured to detect a position of a removable storage medium inside a receptacle of the memory module. The memory module detects a position of a removable storage medium in real-time using a sensor. In other words, in one arrangement, the memory module can detect a physical movement of the removable storage medium inside the memory module in real-time. Using the sensor signals, a visual representation of the movement of the removable storage medium in the memory module as and when the removable storage medium is inserted into or removed from the memory module is rendered on a display of the cellular phone.

The visual representation may also include a still image representing a removable storage medium showing a status of the removable storage medium. Such status information can include available storage capacity, storage capacity in use, stored content details, etc. The visual representation being rendered can also provide an options menu for selecting an action to be performed on the stored content. When a visual representation is provided for each of the removable storage media, then the visual representation can itself be used as a visual aid for managing data. For example, the visual representation can show a moving image indicating sharing of data between a first and a second removable storage medium within the memory module or between at least one of the first and the second removable storage mediums and an embedded memory of the cellular phone.

In an embodiment, the display on which the visual representation is rendered is configured to function as a user interface by means of receiving tactile input on the display. Using the display and the visual representation on the display, a user can easily and quickly manage data by simply performing tactile actions on the image provided in the visual representation. For example, in order to copy an audio clip, a user may select the audio clip by touching the icon representing the audio clip on the image of the first removable storage medium and dragging and dropping the icon onto the image of the second removable storage medium.

Advantageously, the method can allow easy and fast management of data with a cellular phone using a memory module capable of simultaneously receiving and processing multiple removable storage media along with a visual aid.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of managing data in a cellular phone, the method comprising:
providing a cellular phone with a memory module;
coupling at least a first and a second removable storage medium to the memory module; and
managing data with the memory module, for use in connection with the cellular phone.

2. The method of claim 1, further comprising detecting whether at least one of the first and the second removable storage medium is connected to the memory module; and providing a visual representation of the connection to the memory module, in real-time.

3. The method of claim 1, wherein the coupling step includes populating at least the first and the second removable storage medium to the memory module inside the cellular phone.

4. The method of claim 1, wherein the coupling step includes electrically connecting at least the first and the second removable storage medium to the memory module via a serial or parallel connection.

5. The method of claim 1, wherein managing data with the memory module comprises managing data between the first removable storage medium and the second removable storage medium.

6. A method of managing data in a cellular phone, the method comprising:
providing a cellular phone with a memory module;
detecting whether a removable storage medium is connected to the memory module;
rendering a visual representation of the removable storage medium in real-time; and
managing data with the memory module based on the visual representation.

7. The method of claim 6, wherein providing a cellular phone with a memory module comprises providing a memory module for connecting at least two removable storage media.

8. The method of claim 6, wherein the providing step including locating the memory module inside the cellular phone.

9. The method of claim 6, wherein the detecting step includes detecting a position of the removable storage medium inside the memory module.

10. The method of claim 6, wherein the rendering step includes providing a visual representation of a physical movement of the removable storage medium in the memory module as and when the removable storage medium is inserted into or removed from the memory module.

11. The method of claim 6, wherein the rendering step includes providing a visual representation showing content information of the removable storage medium.

12. The method of claim 6, wherein the managing step includes sharing of data between at least one of a first and a second removable storage medium and providing a visual representation indicating the sharing, in real-time.

13. A cellular phone for managing data, the cellular phone comprising:
a housing including a memory module configured to receive at least one removable storage medium;
a sensor for detecting a position of the at least one removable storage medium within the memory module; and
a controller coupled to the sensor, wherein the controller is configured to manage data in the memory module.

14. The cellular phone of claim 13, wherein the contact is configured to detect a change in position of the at least one removable storage medium within the removable memory module as and when the at least one removable storage medium is inserted into the module.

15. The cellular phone of claim 13, wherein the controller is further configured to provide a visual representation of the position of the at least one removal storage medium within the housing in real-time.

16. A cellular phone for managing data, the cellular phone comprising:
a memory module having at least two receptacles each configured to receive a removable storage medium, the memory module including,
a contact for electrically coupling at least one removable storage medium within the removable memory module; and
a controller coupled to the contact, wherein the controller is configured to manage data between the at least two removable storage media.

17. The cellular phone of claim 16, wherein the removable storage medium includes one of USB drives or flash memory cards.

18. The cellular phone of claim 16, further comprising a display specific to the memory module, wherein the display acts as a user interface for user interaction.

19. The cellular phone of claim 16, wherein the display renders information relating to the memory module.
